(19) United States
(12) Patent Application Publication
(10) Pub. No.: US 2023/0259920 A1
(43) Pub. Date: Aug. 17, 2023

(54) AUTHENTICATION METHOD PERFORMED THROUGH WALLET CONNECTION INTERFACE, AUTHENTICATION SYSTEM, AND COMPUTER READABLE STORAGE MEDIUM

(71) Applicant: HTC Corporation, Taoyuan City (TW)

(72) Inventors: Han-Kuan Yu, Taoyuan City (TW); Ming-Te Liu, Taoyuan City (TW); Guo Chao Lin, Taoyuan City (TW); Meng-Hsi Chuang, Taoyuan City (TW)

(73) Assignee: HTC Corporation, Taoyuan City (TW)

(21) Appl. No.: 17/952,349

(22) Filed: Sep. 26, 2022

Related U.S. Application Data
(60) Provisional application No. 63/310,111, filed on Feb. 15, 2022.

(51) Int. Cl. G06Q 20/36; G06Q 20/10; G02B 27/01

(52) U.S. Cl. CPC G06Q 20/3674; G06Q 20/105; G02B 27/017

(57) ABSTRACT

The embodiments of the disclosure provide an authentication method performed through a wallet connection interface, an authentication system, and a computer readable storage medium. The method includes: in response to determining that an authentication function of an application on a wearable device is triggered by a user, generating authentication information related to the wallet connection interface; sending the authentication information to a smart device and a server corresponding to the wallet connection interface; in response to receiving the authentication information, providing wallet information of a wallet application of the smart device to the server, wherein the authentication information and the wallet information are for triggering the server to make a match between the wearable device and the smart device; and in response to determining that the wearable device has been matched with the smart device, determining that the user has been authenticated.

### CROSS-REFERENCE TO RELATED APPLICATION

This application claims the priority benefit of U.S. provisional application Ser. No. 63/310,111, filed on Feb. 15, 2022. The entirety of the above-mentioned patent application is hereby incorporated by reference herein and made a part of this specification.

### BACKGROUND

### 1. Field of the Invention

The present disclosure generally relates to an authentication mechanism, in particular, to an authentication method performed through a wallet connection interface, an authentication system, and a computer readable storage medium.

### 2. Description of Related Art

See FIG. 1A, which shows a scenario of scanning information shown on an electronic device by using a smart device. In some scenarios (e.g., authentications for mobile payment, adding friends on communication applications), the electronic device 110 (e.g., a laptop) may show information such as the quick response (QR) code Cl for the user to scan with the smart device 120 (e.g., using the camera of the smart device 120 to shoot the QR code C1). Since the QR code C1 is shown on the display of the electronic device 110, it would be easy for the user to scan the QR code Cl with the smart device 120, and the smart device 120 can use the information in the QR code C1 to perform subsequent operations, such authenticating the user.

However, if the QR code C1 is shown on a particular display which is difficult for the smart device 120 to scan, the mechanism in FIG. 1A cannot be used for the smart device 120 to obtain the information in the QR code C1.

See FIG. 1B, which shows a scenario of providing scannable information on a wearable device. In FIG. 1B, the wearable device 130 may be, for example, a head-mounted display (HMD) using a near eye display to show visual contents (e.g., virtual reality (VR) contents) for the wearer to see. In this case, if the wearable device 130 shows the QR code C1 in the provided visual content, it would be difficult for the user to scan the QR code C1 with the smart device 120 since the QR code C1 is shown by the near eye display of the wearable device 130.

Therefore, a new mechanism has to be designed for solving the above problem.

### SUMMARY OF THE INVENTION

Accordingly, the disclosure is directed to an authentication method performed through a wallet connection interface, an authentication system, and a computer readable storage medium, which may be used to solve the above technical problems.

The embodiments of the disclosure provide an authentication method performed through a wallet connection interface, including: in response to determining that an authentication function of an application on a wearable device is triggered by a user, generating, by the wearable device, authentication information related to the wallet connection interface; sending, by the wearable device, the authentication information to a smart device and a server corresponding to the wallet connection interface; in response to receiving the authentication information, providing, by the smart device, wallet information of a wallet application of the smart device to the server, wherein the authentication information and the wallet information are for triggering the server to make a match between the wearable device and the smart device; and in response to the wearable device determining that the wearable device has been matched with the smart device, determining, by the wearable device, that the user has been authenticated.

The embodiments of the disclosure provide an authentication system including a wearable device and a smart device. The wearable device is configured to perform: in response to determining that an authentication function of an application on a wearable device is triggered by a user, generating authentication information related to the wallet connection interface; sending the authentication information to the smart device and a server corresponding to a wallet connection interface. The smart device is coupled to the wearable device and configured to perform: in response to receiving the authentication information, providing wallet information of a wallet application of the smart device to the server, wherein the authentication information and the wallet information are for triggering the server to make a match between the wearable device and the smart device. In response to the wearable device determining that the wearable device has been matched with the smart device, the wearable device determines that the user has been authenticated.

The embodiments of the disclosure provide a computer readable storage medium, the computer readable storage medium recording an executable computer program, the executable computer program being loaded by an authentication system to perform steps of: in response to determining that an authentication function of an application on a wearable device is triggered by a user, generating authentication information related to the wallet connection interface; sending the authentication information to a smart device and a server corresponding to the wallet connection interface; in response to receiving the authentication information, providing wallet information of a wallet application of the smart device to the server, wherein the authentication information and the wallet information are for triggering the server to make a match between the wearable device and the smart device; and in response to determining that the wearable device has been matched with the smart device, determining that the user has been authenticated.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1A shows a scenario of scanning information shown on an electronic device by using a smart device.

FIG. 1B shows a scenario of providing scannable information on a wearable device.

FIG. 2 shows a schematic diagram of an authentication system according to an embodiment of the disclosure.

FIG. 3 shows a flow chart of an authentication method performed through a wallet connection interface according to an embodiment of the disclosure.

FIG. 4 shows an application scenario according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

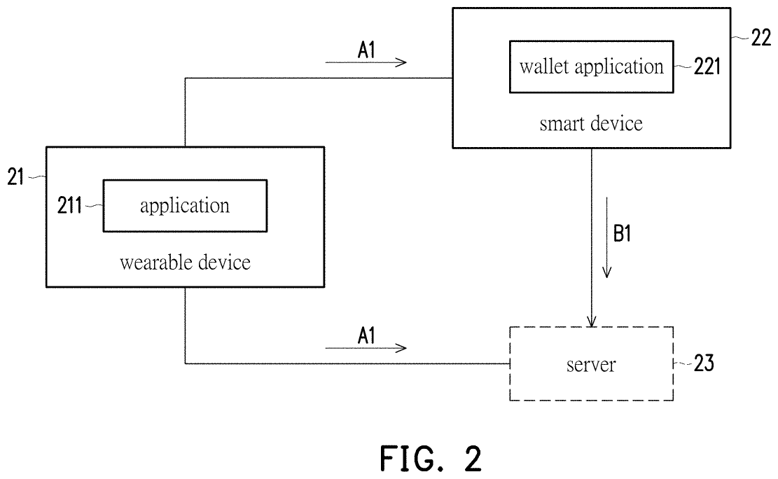

See FIG. 2, which shows a schematic diagram of an authentication system according to an embodiment of the disclosure. In FIG. 2, the authentication system 20 includes a wearable device 21 and a smart device 22. In various embodiments, the wearable device 21 can be any device that can be worn on the user thereof and show contents (e.g., the user interface) related to an application 211 for the user to see, such as augmented reality (AR) glasses and/or the HMD with the near eye display, but the disclosure is not limited thereto.

In some embodiments, the application 211 can be a decentralized application (Dapp) operated based on a block chain and can be used by the user to purchase products (e.g., such as Non-fungible token (NFT)), but the disclosure is not limited thereto.

In some embodiments, the smart device 22 can be a smart phone, a tablet or other devices that can run a wallet application 221. In some embodiments, the wallet application 221 can be a crypto wallet stored with the corresponding cryptocurrency, but the disclosure is not limited thereto.

In one embodiment, if the user wants to use the cryptocurrency in the wallet application 221 to, for example, purchase the NFT through the Dapp, the Dapp may need to ask the user to do some operation for authenticating the user.

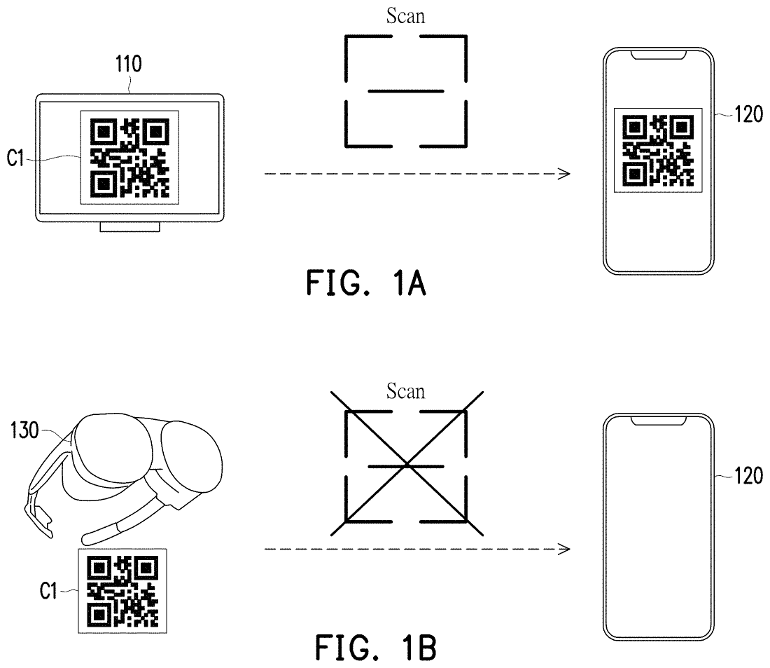

Conventionally, if the Dapp is run on a device such as the electronic device 110 in FIG. 1A, the Dapp can directly show the QR code C1 used for authenticating the user and ask the user to scan with the smart device 22, wherein the QR code C1 may include authentication information for triggering a server 23 related to a wallet connection interface to make a match between the electronic device 110 and the smart device 22 via the wallet connection interface.

However, in the embodiments where the wearable device 21 is, for example, the HMD, it would be difficult for the smart device 22 to scan the QR code C1, which makes the server 23 incapable of making a match between the wearable device 21 and the smart device 22. In this case, the user would not be allowed to use the crypto currency in the wallet application 221 to, for example, purchase the NFT through the Dapp.

Therefore, the embodiments of the disclosure provide a solution for the wearable device 21 and the smart device 22 to exchange the authentication information in a novel way, such that the server 23 can make a match between the wearable device 21 and the smart device 22 even if the wearable device 21 cannot provide the authentication information in a scannable form. Details would be introduced in the following.

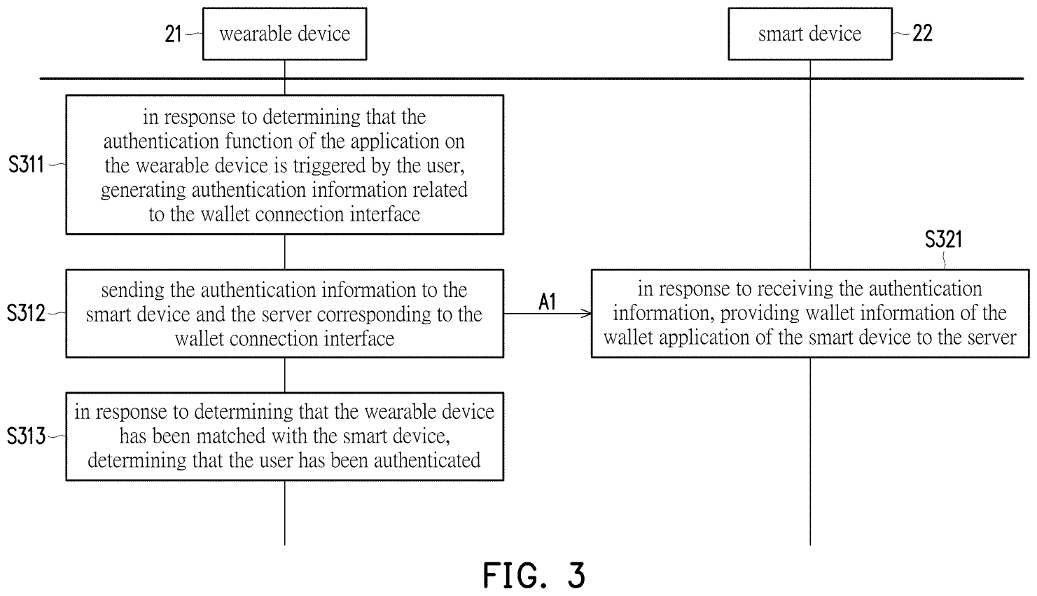

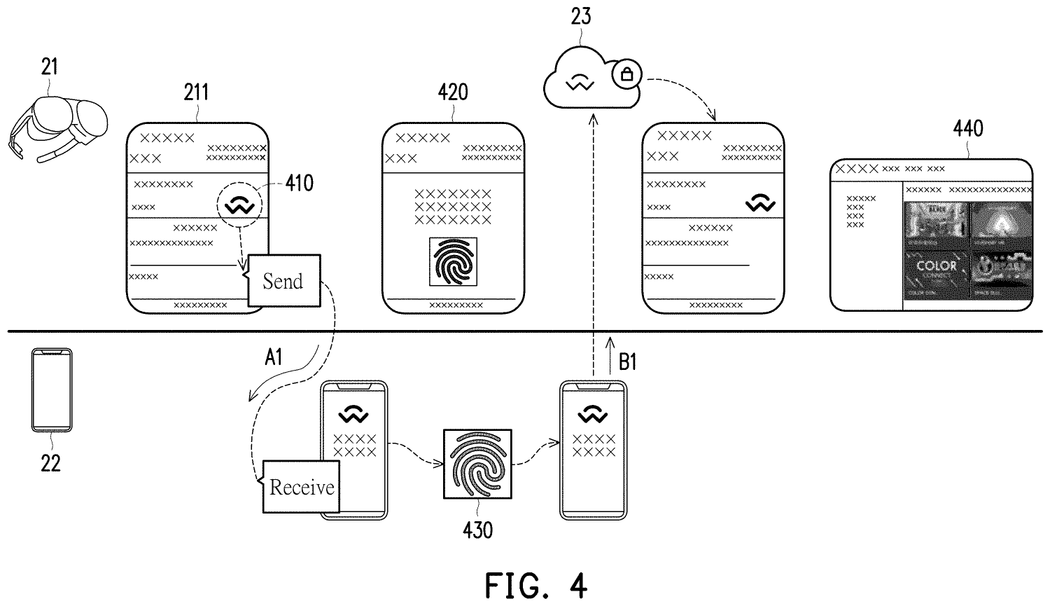

See FIG. 3, which shows a flow chart of an authentication method performed through a wallet connection interface according to an embodiment of the disclosure. The method of this embodiment may be executed by the wearable device 21 and the smart device 22 in FIG. 2, and the details of each step in FIG. 3 will be described below with the components shown in FIG. 2. For better explaining the concept of the disclosure, FIG. 4 would be used as an illustrative example, wherein FIG. 4 shows an application scenario according to an embodiment of the disclosure.

In the scenario of FIG. 4, when the user of the wearable device 21 wants to, for example, login the application 211 (which may be a Dapp) to purchase products (e.g., NFT), the user may trigger an authentication function of the application 211 via selecting an icon 410 with, for example, a hand gesture recognized by the wearable device 21 or a handheld controller connected to the wearable device 21, but the disclosure is not limited thereto.

In step S311, in response to determining that the authentication function of the application 211 on the wearable device 21 is triggered by the user, the wearable device 21 generates authentication information A1 related to the wallet connection interface. In the embodiments of the disclosure, the considered wallet connection interface can be, for example, a WalletConnect interface or other interface capable of connecting the application 211 with the wallet application 221, but the disclosure is not limited thereto. For better understanding the disclosure, the WalletConnect would be used as an example of the wallet connection interface in the following embodiments.

In one embodiment, the authentication information Al may include a unique identifier and a server address of the server 23 (e.g., a WalletConnect server), but the disclosure is not limited thereto.

In step S312, the wearable device 21 sends the authentication information Al to the smart device 22 and the server 23 corresponding to the wallet connection interface.

In one embodiment, the authentication information Al can transmitted to the smart device 22 in a form of a deep link corresponding to the wallet application. In one embodiment, the deep link may be a string started with “wc:” and include data fields corresponding to the authentication information Al (e.g., the unique identifier and the server address of the server 23), but the disclosure is not limited thereto.

In one embodiment, after sending the authentication information Al to the smart device 22 and the server 23, the wearable device 21 may wait for the user to provide identification information (e.g., a fingerprint 430 of the user) to the smart device 22 and show a waiting interface 420 while waiting, but the disclosure is not limited thereto.

Correspondingly, the smart device 22 may receive the authentication information A1 from the wearable device 21. In one embodiment, for facilitating the transmission of the authentication information A1 between the wearable device 21 and the smart device 22, the wearable device 21 and the smart device 22 can be designed with corresponding transmission modules/circuits (which can be understood as corresponding to the box labeled as “Send” in FIG. 4). For example, the wearable device 21 can be designed with a transmitting circuit (e.g., a Bluetooth module) for transmitting the authentication information Al in response to the generated authentication information A1. Correspondingly, the smart device 22 can be designed with a receiving circuit (e.g., a Bluetooth module, which can be understood as corresponding to the box labeled as “Receive” in FIG. 4)) for receiving the authentication information Al from the wearable device 21, but the disclosure is not limited thereto.

Specifically, since the conventionally generated authentication information can be shown in a scannable form (e.g., the QR code C1) for scanning, the device (e.g., the electronic device 110) generating authentication information does not need to additionally send the generated authentication information to, for example, the smart device 22.

On the contrary, since the wearable device 21 may not characterize the authentication information A1 in a scannable form, the wearable device 21 can send the authentication information A1 to the smart device 22 via the transmitting circuit in response to the authentication function and/or the authentication information A1. That is, the 10 wearable device 21 provides the authentication information A1 to the smart device 22 in a novel way.

In step S321, in response to receiving the authentication information A1, the smart device 22 provides wallet information B1 of the wallet application 221 of the smart device 22 to the server 23. In one embodiment, the wallet information B1 may include a public address of the wallet application 221 of the smart device 22.

In one embodiment, the smart device 22 may send the wallet information B1 of the wallet application 221 to the server 23 based on the unique identifier and the server address of the server 23.

In one embodiment, before providing the wallet information B1 of the wallet application 221 of the smart device 22 to the server 23, the smart device 22 may requesting the user to provide identification information to the smart device 22. For example, the smart device 22 may request the user to input a biometric identification (e.g., the fingerprint 430) to the smart device 22, but the disclosure is not limited thereto.

In response to determining that the identification information has been verified, the smart device 22 can provide, the wallet information B1 of the wallet application 221 of the smart device 22 to the server 23. On the other hand, in response to determining that the identification information has not been verified, the smart device 22 may not provide the wallet information B1 of the wallet application 221 of the smart device 22 to the server 23 and inform the user that the authentication has failed, but the disclosure is not limited thereto.

In one embodiment, the authentication information A1 and the wallet information B1 can trigger the server 23 to make a match between the wearable device 21 and the smart device 22. In the embodiment where the server 23 is a WalletConnect server, the details of the operations of making a match between the wearable device 21 and the smart device 22 can be referred to the specification of WalletConnect, and the details of the required authentication information Al and the wallet information B1 can be also referred to the specification of WalletConnect, but the disclosure is not limited thereto.

In one embodiment, the server 23 may inform the wearable device 21 that the wearable device 21 has been matched with the smart device 22 via, for example, signed messages defined in the specification of WalletConnect.

Accordingly, in step S313, in response to determining that the wearable device 21 has been matched with the smart device 22, the wearable device 21 determines that the user has been authenticated.

In one embodiment, after receiving, for example, the signed messages defined in the specification of WalletConnect from the server 23, the wearable device 21 may determine that the wearable device 21 has been matched with the smart device 22, but the disclosure is not limited thereto.

In one embodiment, once the user has been authenticated, the wearable device 21 may allow the user to, for example, login the application 211 to perform a transaction via the wallet application 221. For example, the wearable device 21 may allow the user to purchase products such as NFT in the user interface 440 of the application 211, but the disclosure is not limited thereto.

In one embodiment, the method in FIG. 3 can be performed whenever the user wants to purchase products via the application 211. For example, when the user determines to checkout with the selected products, the wearable device 21 may show the icon 410 in the user interface of the application 211. Once the user triggers the icon 410, the steps in FIG. 3 can be executed again for authenticating the user. After determining that the user has been authenticated, the user can be allowed to use the cryptocurrency in the wallet application 221 to pay for the selected products in the application 211, but the disclosure is not limited thereto.

The disclosure further provides a computer readable storage medium for executing the authentication method. The computer readable storage medium is composed of a plurality of program instructions (for example, a setting program instruction and a deployment program instruction) embodied therein. These program instructions can be loaded into the wearable device 21 and the smart device 22 and executed by the same to execute the authentication method and the functions of the wearable device 21 and the smart device 22 described above.

In summary, the embodiments of the disclosure provide a solution for the wearable device to send the authentication information to the smart device in response to determining that the authentication function of the application (e.g., a Dapp) has been triggered. Accordingly, the authentication information can be successfully provided to the smart device even if the authentication information cannot be characterized in a scannable form (e.g., a QR code).

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. An authentication method performed through a wallet connection interface, comprising:
in response to determining that an authentication function of an application on a wearable device is triggered by a user, generating, by the wearable device, authentication information related to the wallet connection interface;
sending, by the wearable device, the authentication information to a smart device and a server corresponding to the wallet connection interface;
in response to receiving the authentication information, providing, by the smart device, wallet information of a wallet application of the smart device to the server, wherein the authentication information and the wallet information are for triggering the server to make a match between the wearable device and the smart device; and
in response to the wearable device determining that the wearable device has been matched with the smart device, determining, by the wearable device, that the user has been authenticated.

2. The method according to claim 1, wherein the authentication information comprises a unique identifier and a server address of the server.

3. The method according to claim 2, wherein the step of providing the wallet information of the wallet application of the smart device to the server comprises:
sending, by the smart device, the wallet information of the wallet application to the server based on the unique identifier and the server address of the server.

4. The method according to claim 1, wherein the wallet information comprises a public address of the wallet application of the smart device.

5. The method according to claim 1, wherein the authentication information is transmitted in a form of a deep link corresponding to the wallet application.

6. The method according to claim 1, wherein after the step of sending the authentication information to the smart device and the server corresponding to the wallet connection interface, the method further comprises:
waiting, by the wearable device, for the user to provide identification information to the smart device.

7. The method according to claim 1, wherein before the step of providing the wallet information of the wallet application of the smart device to the server, the method further comprises:
requesting, by the smart device, the user to provide identification information to the smart device;
in response to determining that the identification information has been verified, providing, by the smart device, the wallet information of the wallet application of the smart device to the server;
in response to determining that the identification information has not been verified, not providing, by the smart device, the wallet information of the wallet application of the smart device to the server.

8. The method according to claim 7, wherein the step of requesting the user to provide identification information to the smart device comprises:
requesting, by the smart device, the user to input a biometric identification to the smart device.

9. The method according to claim 1, further comprising:
showing, by the wearable device, a user interface of the application via a near eye display of the wearable device.

10. The method according to claim 1, wherein the application is a decentralized application operated based on a block chain.

11. The method according to claim 10, wherein after the step of determining that the user has been authenticated, the method further comprises:
allowing, by the wearable device, the user to perform a transaction via the wallet application.

12. The method according to claim 10, wherein the wallet application is a crypto wallet.

13. An authentication system, comprising:
a wearable device, configured to perform:
in response to determining that an authentication function of an application on a wearable device is triggered by a user, generating authentication information related to the wallet connection interface;
sending the authentication information to the smart device and a server corresponding to a wallet connection interface;
a smart device, coupled to the wearable device and configured to perform:
in response to receiving the authentication information, providing wallet information of a wallet application of the smart device to the server, wherein the authentication information and the wallet information are for triggering the server to make a match between the wearable device and the smart device;
wherein in response to the wearable device determining that the wearable device has been matched with the smart device, the wearable device determines that the user has been authenticated.

14. The authentication system according to claim 13, wherein the authentication information comprises a unique identifier and a server address of the server, and the smart device sends the wallet information of the wallet application to the server based on the unique identifier and the server address of the server.

15. The authentication system according to claim 13, wherein the wallet information comprises a public address of the wallet application of the smart device.

16. The authentication system according to claim 13, wherein the authentication information is transmitted in a form of a deep link corresponding to the wallet application.

17. The authentication system according to claim 13, wherein before providing the wallet information of the wallet application of the smart device to the server, the smart device performs:
requesting the user to provide identification information to the smart device;
in response to determining that the identification information has been verified, providing the wallet information of the wallet application of the smart device to the server;
in response to determining that the identification information has not been verified, not providing, by the smart device, the wallet information of the wallet application of the smart device to the server.

18. The authentication system according to claim 13, wherein the wearable devices shows a user interface of the application via a near eye display of the wearable device.

19. The authentication system according to claim 13, wherein the application is a decentralized application operated based on a block chain, the wallet application is a crypto wallet, and after determining that the user has been authenticated, the wearable device further allows the user to perform a transaction via the wallet application.

20. A non-transitory computer readable storage medium, the computer readable storage medium recording an executable computer program, the executable computer program being loaded by an authentication system to perform steps of:
in response to determining that an authentication function of an application on a wearable device is triggered by a user, generating authentication information related to the wallet connection interface;
sending the authentication information to a smart device and a server corresponding to the wallet connection interface;
in response to receiving the authentication information, providing wallet information of a wallet application of the smart device to the server, wherein the authentication information and the wallet information are for triggering the server to make a match between the wearable device and the smart device; and
in response to determining that the wearable device has been matched with the smart device, determining that the user has been authenticated.
